(19) United States
(12) Patent Application Publication
(10) Pub. No.: US 2026/0136041 A1
(43) Pub. Date: May 14, 2026

(54) DYNAMIC MESH GEOMETRY DISPLACEMENTS FOR A SINGLE VIDEO PLANE

(71) Applicant: GUANGDONG OPPO MOBILE TELECOMMUNICATIONS CORP., LTD., Dongguan (CN)

(72) Inventors: Vladyslav Zakharchenko, Palo ALto, CA (US); Yue YU, Palo ALto, CA (US); Haoping YU, Palo ALto, CA (US)

(21) Appl. No.: 19/122,990

(22) PCT Filed: Oct. 16, 2023
(86) PCT No.: PCT/US2023/035209

§ 371 Date: Apr. 21, 2025

Related U.S. Application Data
(60) Provisional application No. 63/380,491, filed on Oct. 21, 2022.
(60) Provisional application No. 63/380,741, filed on Oct. 24, 2022.

(51) Int. Cl. H04N 19/54; H04N 19/53; H04N 19/70

(52) U.S. Cl. CPC H04N 19/54; H04N 19/53; H04N 19/70

(57) ABSTRACT

Computer-implemented methods for processing replacement components are provided. The methods include packing/unpacking, in a slice-boundary-aligned arrangement, a plurality of samples belonging to a plurality of LoD associated with a plurality of displacement components, into/from a two-dimensional plane including a plurality of regions, wherein each of the plurality of regions includes at least one slice including a plurality of blocks.

### CROSS-REFERENCE TO RELATED APPLICATION

This application is a national phase entry under 35 USC 371 of International Patent Application No. PCT/US2023/035209 filed on Oct. 16, 2023, which claims the benefit of priorities to U.S. Provisional Applications No. 63/380,491, entitled “DYNAMIC MESH GEOMETRY DISPLACEMENTS SINGLE VIDEO PLANE PACKING,” filed on Oct. 21, 2022, and No. 63/380,741, entitled “DYNAMIC MESH GEOMETRY DISPLACEMENTS SINGLE VIDEO PLANE PACKING,” filed on Oct. 24, 2022, which are hereby incorporated in their entireties by this reference.

### FIELD OF THE DISCLOSURE

The present disclosure relates generally to computer-implemented methods and systems for dynamic mesh processing, and more particularly, to dynamic mesh geometry displacements for a single video plane.

### DESCRIPTION OF THE RELATED ART

In three-dimensional (3D) computer graphics and solid modeling, a polygon mesh is a collection of vertices, edges, and faces that defines the shape of a polyhedral object. For example, a coding method for geometry information is applied, in which a base mesh is subdivided, and displacement components are packed into a two-dimensional (2D) image/video format. However, a process of mapping 3D displacement coefficients to a 2D surface and further video coding does not allow to clearly distinguish samples in the image that belongs to a specified level of details.

This requires to allocate maximum memory even for a partial reconstruction scenario. Thus, there is a need for geometry information improvement.

### SUMMARY

An object of the present disclosure is to propose computer-implemented methods and

systems to improve coding efficiency for dynamic mesh geometry refinement information.

In a first aspect of the present disclosure, a computer-implemented method is provided and includes: unpacking, in a slice-boundary-aligned arrangement, a plurality of samples belonging to a plurality of levels of detail (LoD) associated with a plurality of displacement components, from a two-dimensional plane including a plurality of regions, wherein each of the plurality of regions includes at least one slice including a plurality of blocks.

In a second aspect of the present disclosure, a system is provided and includes: a processor; and a memory coupled to the processor, wherein the processor is configured to execute program instructions stored in the memory to perform the computer-implemented method associated with the first aspect of the present disclosure.

In a third aspect of the present disclosure, a non-transitory computer-readable medium having program code stored thereon, the program code executable by a processor to execute the computer-implemented method associated with the first aspect of the present disclosure.

In a fourth aspect of the present disclosure, a computer-implemented method is provided and includes: packing, in a slice-boundary-aligned arrangement, a plurality of samples belonging to a plurality of levels of detail (LoD) associated with a plurality of displacement components, into a two-dimensional plane including a plurality of regions, wherein each of the plurality of regions includes at least one slice including a plurality of blocks.

In a fifth aspect of the present disclosure, a system includes: a processor; and a memory coupled to the processor, wherein the processor is configured to execute program instructions stored in the memory to perform the computer-implemented method associated with the fourth aspect of the present disclosure.

In a sixth aspect of the present disclosure, a non-transitory computer-readable medium having program code stored thereon, the program code executable by a processor to execute the computer-implemented method associated with the fourth aspect of the present disclosure.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 shows a schematic diagram illustrating a geometry encoder that can be applied to embodiments of the present disclosure.

FIG. 2 shows a schematic diagram illustrating displacements subdivision and approximation process that can be applied to embodiments of the present disclosure.

FIG. 3 shows a schematic diagram illustrating displacement component decomposition in a coordinate system that can be applied to embodiments of the present disclosure.

FIG. 4 shows a schematic diagram illustrating a parametrized mesh coding process in a parametrized mesh coder that can be applied to embodiments of the present disclosure.

FIG. 5 shows a schematic diagram illustrating an example of geometry information in one mesh frame that can be applied to embodiments of the present disclosure.

FIG. 6 shows a schematic diagram illustrating an example of a mesh comprised of four vertices (geometry) and three triangular faces (connectivity) that can be applied to embodiments of the present disclosure.

FIG. 7 shows a schematic diagram illustrating an example of data structure for a parametrized mesh that can be applied to embodiments of the present disclosure.

FIG. 8 shows a schematic diagram illustrating an example of a mesh comprised of four vertices and three triangular faces with a corresponding attribute UV map that can be applied to embodiments of the present disclosure.

FIGS. 9A and 9B show schematic diagrams illustrating examples of face orientation for mesh based on a vertex index order that can be applied to embodiments of the present disclosure.

FIG. 10 shows a flowchart illustrating a computer-implemented method including packing samples in a packing process that can be applied to an example of an encoding process associated with geometry displacement components according to an embodiment of the present disclosure.

FIG. 11 shows a flowchart illustrating a computer-implemented method including unpacking samples in an unpacking process that can be applied to an example of a decoding process associated with geometry displacement components according to an embodiment of the present disclosure.

FIG. 12 shows a schematic diagram illustrating an example of video components for displacement coefficients in an 8×8 packing block that can be applied to embodiments of the present disclosure.

FIG. 13 shows a schematic diagram illustrating examples of geometry subdivision process that can be applied to embodiments of the present disclosure.

FIG. 14 shows a schematic diagram illustrating an example of a hybrid geometry subdivision process that can be applied to embodiments of the present disclosure.

FIG. 15 shows a table illustrating a syntax structure associated with a function, dmesh_sequence_parameter_set_rbsp( ) according to an embodiment of the present disclosure.

FIGS. 16A and 16B show examples of level of detail (LoD)-based packing for displacement wavelet coefficients in two-dimensional (2D) displacement samples according to an embodiment of the present disclosure.

FIG. 17 shows an example of a computing device that can be applied to embodiments of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Currently, three-dimensional (3D) computer graphics and solid modeling are applied in many application scenarios, such as augmented reality (AR).

For illustrative purposes, terms are provided below. Term, “mesh,” refers to a collection of vertices, edges, and faces that defines the shape/topology of a polyhedral object, wherein the faces usually consist of triangles (triangle mesh). Term, “base mesh,” refers to a mesh with fewer vertexes but preserves similarity to the original surface. Term, “dynamic mesh,” refers to a mesh with at least one of the five components, such as connectivity, geometry, mapping, vertex attribute, and attribute map, varying in time. Term, “animated mesh,” refers to a dynamic mesh with constant connectivity. Term, “parametrized mesh,” refers to a mesh with the topology defined as the mapping component. Term, “connectivity,” refers to a set of vertex indices describing how to connect the mesh vertices to create a 3D surface, e.g., geometry and all the attributes share the same unique connectivity information. Term, “geometry,” refers to a set of vertex of 3D (x, y, z) coordinates describing positions associated with the mesh vertices, wherein the (x, y, z) coordinates representing the positions should have finite precision and dynamic range. Term, “mapping,” refers to a description of how to map the mesh surface to two-dimensional (2D) regions of the plane, e.g., such mapping is described by a set of UV parametric/texture mapping coordinates associated with the mesh vertices together with the connectivity information. Term, “vertex attribute,” refers to a scalar of vector attribute values associated with the mesh vertices. Term, “attribute map,” refers to attributes associated with the mesh surface and stored as 2D images/videos, wherein the mapping between the videos (i.e., parametric space) and the surface is defined by the mapping information. Term, “vertex,” refers to a position (usually in 3D space) along with other information such as color, normal vector, and texture coordinates. Term, “edge,” refers to a connection between two vertices. Term, “face,” refers to a closed set of edges in which a triangle face has three edges defined by three vertices, wherein orientation of the face is determined using a “right-hand” coordinate system. Term, “surface,” refers to a collection of faces that separates the three-dimensional object from the environment. Term “bpp” refers to bits per point, an amount of information in terms of bits required to describe one point in the mesh. Term, “displacements,” refer to the difference between the original mesh geometry and the mesh geometry reconstructed due to the base mesh subdivision process. Term, “LoD (level of details),” refers to scalable representation of mesh reconstruction, each level of detail contains enough information to reconstruct mesh to an indicated precision or spatial resolution, wherein each following level of detail is a refinement on top of the plurality of previously reconstructed mesh.

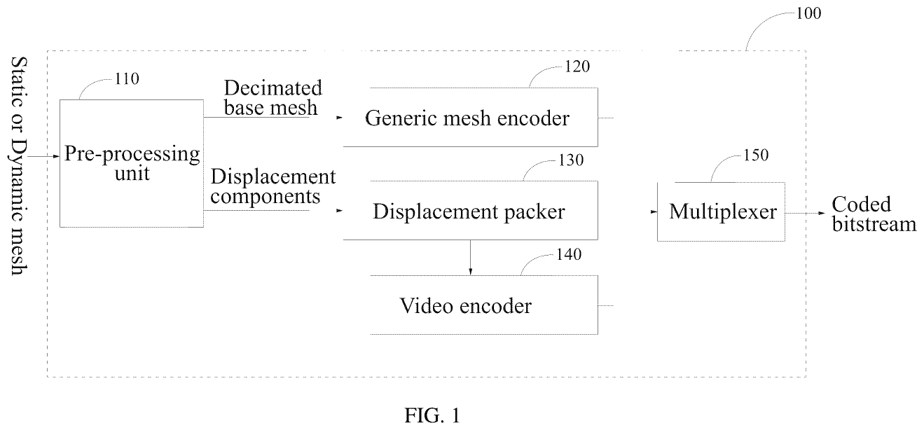

For example, in three-dimensional (3D) computer graphics and solid modeling, a polygon mesh is a collection of vertices, edges, and faces that defines the shape of a polyhedral object. For example, current algorithms apply two-stage encoding to encode geometry information. A high-level diagram of the two-stage geometry coding process is described in FIG. 1.

For example, FIG. 1 shows a schematic diagram illustrating a geometry encoder 100, which includes a pre-processing unit 110, a generic mesh encoder 120, a displacement packer 130, a video encoder 140, and a multiplexer 150. The pre-processing unit 110 is capable of base geometry and displacements generation to provide a decimated based mesh and displacement components according to a static or dynamic mesh. The generic mesh encoder 120 is capable of processing the decimated based mesh in generic mesh encoding to generate mesh-coded data. The displacement packer 130 is capable of packing the displacement components into a two-dimensional (2D) image. The video encoder 140 is capable of processing the two-dimensional image in video coding for displacements to generate video-coded data. The multiplexer 150 is capable of multiplexing the mesh-coded data and video-coded data into a coded bitstream.

For example, as shown in FIG. 1, first, geometry data is decimated to create a base mesh encoded using generic geometry coding methods, i.e., “edgebreaker”; then, the base mesh is hierarchically subdivided, and the difference between the subdivided point and the approximation of the original mesh is stored as the geometry displacement components. The displacement components are packed into the two-dimensional image and encoded with lossless video coding methods such as high efficiency video coding (HEVC).

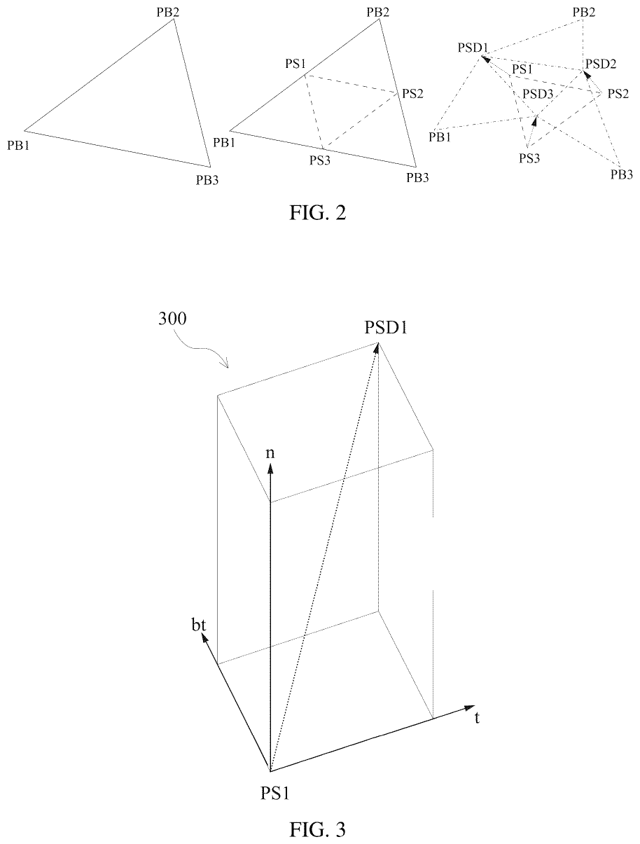

For example, as shown in FIG. 2, which shows a schematic diagram illustrating displacements subdivision and approximation process. In FIG. 2, a displacement generation process for one face in a base mesh with one refinement step is illustrated, e.g., PB1, PB2, and PB3 denote the base mesh points; PS1, PS2, and PS3 represent subdivided points; and PSD1, PSD2, and PSD3 represent subdivided displaced points. For example, the subdivided point PS1 is calculated as a mid-point between the base mesh points PB1 and PB2. The calculating process can be recursively repeated. In an example, as shown in FIG. 2, three replacement vectors, i.e., a vector from PS1 to PSD1, a vector from PS2 to PSD2, and a vector from PS3 to PSD3 are pointing in different directions.

For example, as shown in FIG. 3, which shows a schematic diagram illustrating displacement component decomposition in a coordinate system 300, In FIG. 3, a vector from a point (such as a base mesh point PS1) to a point (such as a subdivided displaced point PSD1) is described as three components in normal (n), tangent (t), and bitangent (bt) directions that are further processed with wavelet transform, and corresponding transform coefficients are mapped to color planes (e.g., Y, U, and V components in YUV 444 color space).

It should be note that a process of mapping 3D displacement coefficients to a 2D surface and further performing video coding does not allow to clearly distinguish the samples in the image that belong to a specified level of details. This requires to allocate maximum memory even for a partial reconstruction scenario.

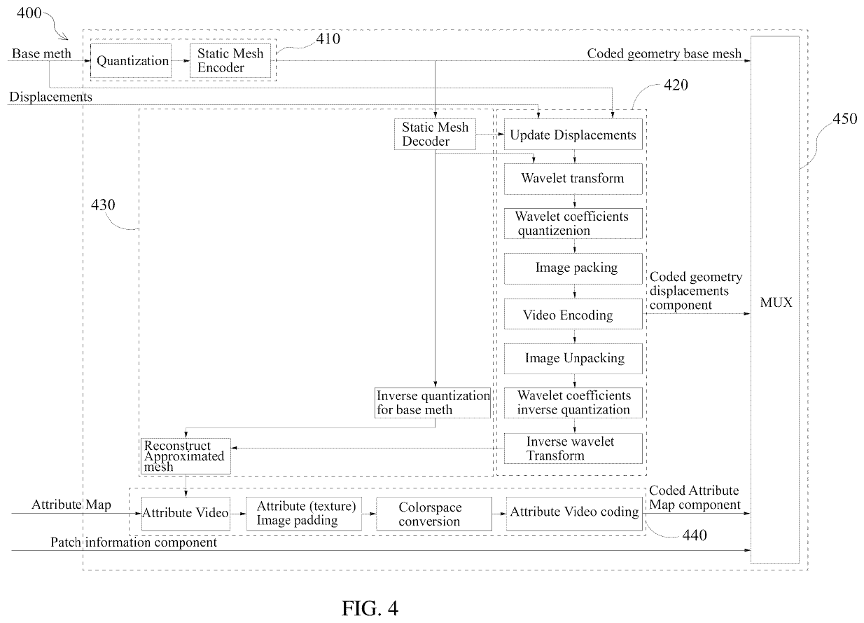

For example, as shown in FIG. 4, which shows a schematic diagram illustrating a parametrized mesh coding process in a parametrized mesh coder 400. The parametrized mesh coder 400 includes a mesh coding part 410, a displacements coding part 420, a mesh reconstruction part 430, an attribute map processing part 440, and a multiplexer (MUX) 450. The mesh coding part 410 is capable of processing data associated with a base mesh in quantization and static mesh encoding to generate coded geometry base mesh data. The displacements coding part 420 is capable of processing data associated with displacements in updating, transform, quantization, packing, video encoding, image unpacking, inverse quantization, and inverse transform, wherein coded geometry displacements component data is generated in video encoding. The mesh reconstruction part 430 is capable of processing data processed by the mesh coding part 410 in static mesh decoding, inverse quantization, and approximated mesh reconstruction. The attribute map processing part 440 is capable of processing data associated with attribute map in video attribution, attribute (texture) image padding, color space conversion, and attribute video coding to generate coded attribute map component data. The multiplexer 450 is capable of multiplexing data output from the mesh coding part 410, the displacements coding part 420, and the attribute map processing part 440 to generate a coded bitstream.

For example, as shown in FIG. 4, a base mesh frame is quantized and encoded using a static mesh encoder. The process is agnostic of which mesh encoding scheme is used to compress the base mesh. The displacements are processed by a hierarchical wavelet (or another) transform that recursively applies refinement layers to the reconstructed base mesh. In one aspect, the wavelet coefficients are then quantized, packed into a 2D image/video, and can be compressed by using an image/video encoder such as HEVC. In another aspect, the reconstructed wavelet coefficients are obtained by applying image unpacking and inverse quantization to the reconstructed wavelet coefficients of an image/video generated during an image/video decoding process. Further, reconstructed displacements are then computed by applying the inverse wavelet transform to the reconstructed wavelet coefficients.

For example, wavelet coefficients are calculated in floating-point format and can be positive and negative. In a respective art to compose a 2D image, the coefficients are first converted to positive and mapped to a given bit-depth, illustrated as below:

c′(i)=2\hat{ }[bit_depth−1]+[c(i)*2\hat{ }bit_depth]/[c_max−c_min],

wherein c′(i) is integerized displacement coefficient value, c(i) is a current displacement coefficient, c_max is a maximum displacement coefficient value, c_min is a minimum displacement coefficient value, and bit-depth is a value that defines a number of fixed levels for image coding.

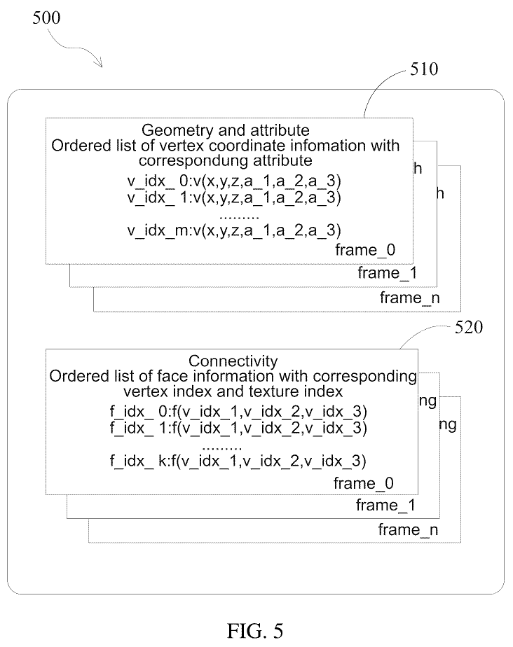

In addition, FIG. 5 shows a schematic diagram illustrating an example of geometry information in one mesh frame. In FIG. 5, mesh frame 500 associated with color-per-vertex approaches are provided, wherein geometry and attribute information 510 can be stored in mesh frames as an ordered list of vertex coordinate information stored with corresponding geometry and attribute information, and connectivity information 520 can be stored in mesh frames as an ordered list of face information including corresponding vertex indices and texture indices. For example, as shown in FIG. 5, a surface, represented by a mesh with color per vertex characteristics that consists of four vertices and three faces, is demonstrated. In an example, a position in space describes each vertex by X, Y, Z coordinates and color attributes R, G, B.

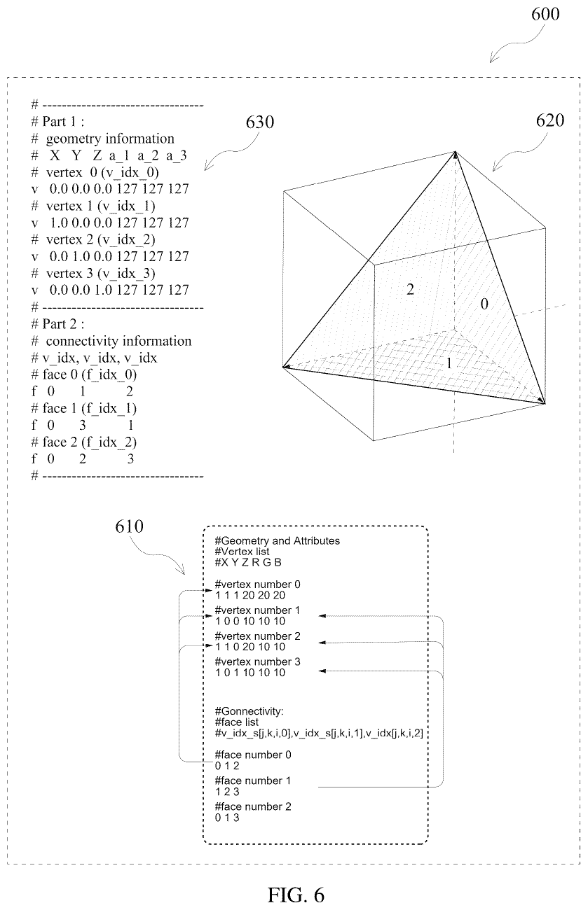

In addition, FIG. 6 shows a schematic diagram illustrating an example 600 of a mesh including four vertices (geometry) and three triangular faces (connectivity). In FIG. 6, a mesh frame 610, a corresponding three-dimensional (3D) content 620, and an underlying defining data 630 associated with color-per-vertex approaches are illustrated. As illustrated in the mesh frame 610 and the corresponding data 630, geometry coordinates with associated attribute information and connectivity information are stored in a mesh frame, wherein geometry and attribute information are stored as an ordered list of vertex geometry coordinate information with associated attribute information, and connectivity information is stored as an ordered list of face information with corresponding vertex indices. The geometry and attribute information illustrated in the mesh frame 610 includes four vertices. The positions of the vertices are indicated by X, Y, Z coordinates and color attributes are indicated by a_1, a_2, a_3 values that represent the R, G, B color prime values. The connectivity information illustrated in the mesh frame 610 includes three faces. As shown in FIG. 6, each face is defined by three vertex indices that form a triangle. Each face includes three vertex indices listed in the geometry and attribute information to form a triangle face. The 3D content 620 (e.g., a 3D triangle with three faces 0, 1, 2 that are bounded by three axes such as X, Y, Z) can be decoded based on the mesh frames 610 by using the vertex indices for each corresponding face to point to the geometry and attribute information stored for each vertex coordinate.

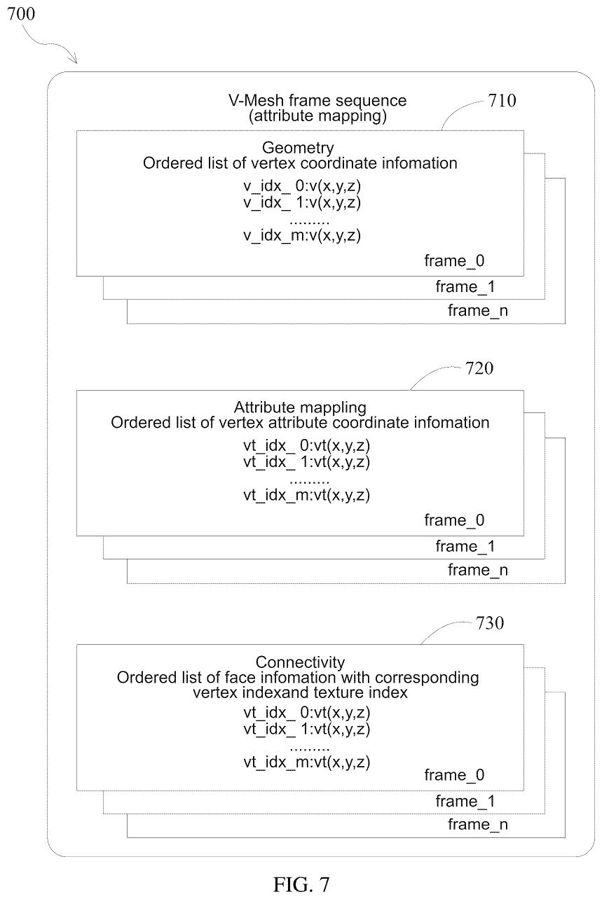

In addition, FIG. 7 shows a schematic diagram illustrating an example 700 of data structure for a parametrized mesh. In FIG. 7, uncompressed mesh frames, such as “frame_0”, “frame_1”, . . . , and “frame_n”, are associated with 3D coding approaches using texture maps; geometry information 710 can be stored in mesh frames as an ordered list of vertex coordinate information, wherein each vertex coordinate is stored with corresponding geometry information; attribute information 720 can be stored in mesh frames, separated from the geometry information 710, as an ordered list of projected vertex attribute coordinate information, wherein the projected vertex attribute coordinate information is stored as 2D coordinate information with corresponding attribute information; connectivity information 730 can be stored in mesh frames as an ordered list of face information, with each face including corresponding vertex indices and texture indices.

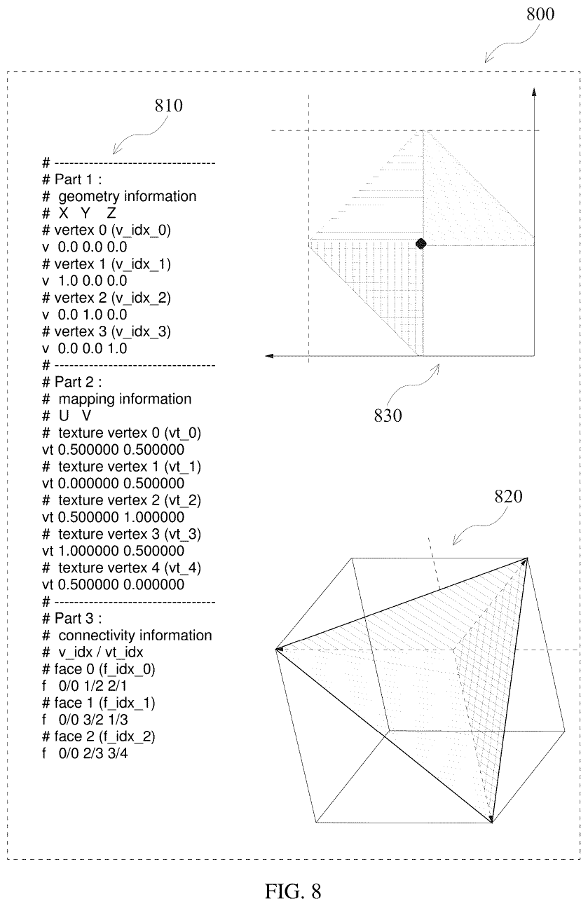

For example, FIG. 7 illustrates an example of a surface represented by a mesh with attribute mapping characteristics that consists of four vertices and three faces, which is demonstrated in FIG. 8. A position in space describes each vertex by X, Y, Z coordinates. (U, V) denotes attribute coordinates in a 2D texture vertex map. Each face is defined by three pairs of vertex indices and texture vertex coordinates that form a triangle in a 3D space and a triangle in the 2D texture map.

In addition, FIG. 8 shows a schematic diagram illustrating an example 800 of a mesh including four vertices and three triangular faces with a corresponding attribute UV map. In FIG. 8, data 810 defining a mesh frame, a corresponding 3D content 820, and a corresponding attribute map 830 associated with 3D coding approaches using attribute mapping are illustrated. As illustrated in FIG. 8, geometry information, mapping information (e.g., attribute information), and connectivity information are stored in the mesh frame generated based on information described in data 810. The geometry information contained in the mesh frame includes four vertices. The positions of the vertices are indicated by X, Y, Z coordinates. The mapping information in the mesh frame includes five texture vertices. The positions of the texture vertices are indicated by U, V coordinates. The connectivity information in the mesh frame includes three faces. Each face includes three pairs of vertex indices and texture vertex coordinates. As illustrated in FIG. 8, the 3D content 820 (e.g., the object formed by the triangles in the 3D space) and the attribute map 830 can be decoded based on the mesh frame by using the pairs of vertex indices and texture vertex coordinates for each face. Attribute information associated with the attribute map 830 can be applied to the 3D content 820 to apply the attribute information to the 3D content 820.

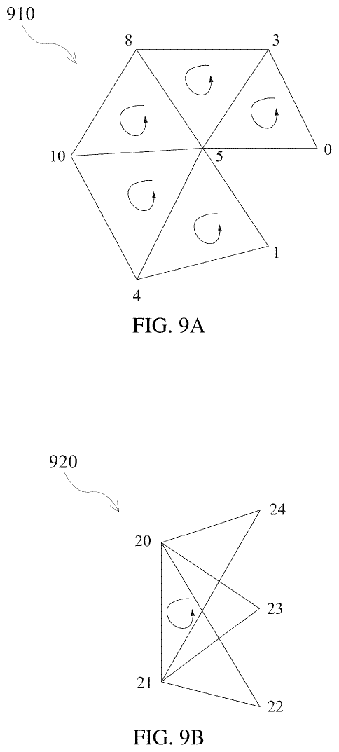

In addition, FIGS. 9A and 9B show schematic diagrams illustrating examples of face orientation for mesh based on a vertex index order. For example, as shown in FIGS. 9A and 9B, an orientation of the face can be determined using the right-hand coordinate system, wherein the face consists of three vertices that belong to three edges, and the three vertex indices describe each face. Face orientation for mesh based on vertex index order is provided. As illustrated in FIGS. 9A and 9B, a manifold mesh 910 is a mesh where one edge belongs to two different faces at most, and a non-manifold mesh 920 is a mesh with an edge that belongs to more than two faces.

In an implementation to encode displacement components using video encoding standards, the transformed displacement components are mapped from a one-dimensional (1D) array to a two-dimensional (2D) image, in which each component unit vector is associated with a different color plane. For example, a normal (n) unit vector is mapped to a Y-plane, a tangent (t) unit vector is mapped to a U-plane, and a bitangent (bt) unit vector is mapped to a V-plane. In this example, YUV444 color mapping can be used for encoding. However, implementations are not limited to the above, e.g., the different vectors such as normal, tangent, and bi-tangent can be mapped into a single two-dimensional plane, such as a Y-plane, in a color space, such as YUV 4:0:0, YUV 4:2:0, or other representation, to represent displacement data such as different displacement components.

It should be noted that, in the present disclosure, the overall idea of padding is provided to align the data in the image to the boundary of at least one slice, in a corresponding image/video codec used for displacement component coding. Thus, each LoD may correspond to a dedicated slice such as using slices starting from the low LoD to the high LoD to support partial coding and improve coding efficiency for dynamic mesh geometry refinement information.

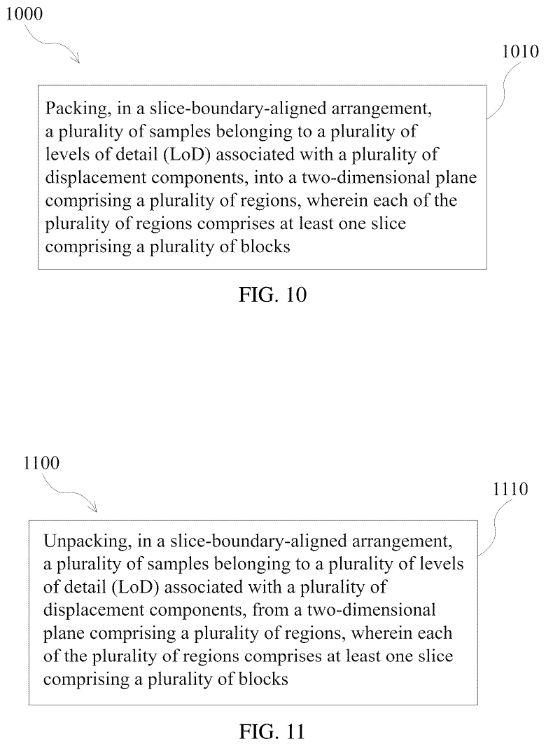

For example, FIG. 10 shows a flowchart illustrating a computer-implemented method including packing samples such as displacement wavelet coefficients in a packing process that can be applied to an example of an encoding process associated with geometry displacement components according to an embodiment of the present disclosure. As shown in FIG. 10, a computer-implemented method 1000 is provided and includes: a box 1010, packing, in a slice-boundary-aligned arrangement, a plurality of samples belonging to a plurality of levels of detail (LoD) associated with a plurality of displacement components, into a two-dimensional plane including a plurality of regions, wherein each of the plurality of regions includes at least one slice including a plurality of blocks.

In this example, the 2D plane can be a representation of a 2D image including several samples which can be encoded into/decoded from a bitstream associated with geometry displacement components; the slice-boundary-aligned arrangement is indicative of that samples of one LoD including a plurality of LoD components (such as “normal_LoD_i”, “tangent_LoD_i”, and “bi-tangent_LoD_i”, wherein i=0 to a positive integer n) associated with the plurality of displacement components (such as normal, tangent, and bi-tangent displacement components) are aligned (such as being started at a first index associated with a two-dimensional scan order) with a boundary of a slice including several blocks such as CTUs in an image format.

Correspondingly, FIG. 11 shows a flowchart illustrating a computer-implemented method including unpacking samples such as displacement wavelet coefficients in an unpacking process that can be applied to an example of a decoding process associated with geometry displacement components according to an embodiment of the present disclosure. As shown in FIG. 11, a computer-implemented method 1100 is provided and includes: a box 1110, unpacking, in a slice-boundary-aligned arrangement, a plurality of samples belonging to a plurality of levels of detail (LoD) associated with a plurality of displacement components, from a two-dimensional plane including a plurality of regions, wherein each of the plurality of regions includes at least one slice including a plurality of blocks.

In some embodiments, as shown at the box 1010 in FIG. 10 and the box 1110 in FIG. 11, each of the plurality of levels of detail includes a plurality of LoD components associated with the plurality of displacement components including a normal displacement component, a tangent displacement component, and a bi-tangent displacement component.

In some embodiments, as shown at the box 1010 in FIG. 10 and the box 1110 in FIG. 11, each of the plurality of blocks is a two-dimensional sub-plane associated with a macroblock (MB), a coding tree unit (CTU), a transform unit (TU), a prediction unit (PU), or a coding unit (CU) within the two-dimensional plane.

In some embodiments, as shown at the box 1010 in FIG. 10 and the box 1110 in FIG. 11, the plurality of samples are associated with a plurality of quantized transform coefficients, a plurality of transformed coefficients, or a plurality of displacement coefficients associated with the plurality of displacement components.

In the present disclosure, some examples between the packing/unpacking process in a continuous/slice-aligned manner is provided for the description as follows. To simplify the description, examples regarding a slice-boundary-aligned arrangement with quantized transform coefficients within coding tree units (CTU) in slices are provided as follows. Still, they are not intended to limit the disclosure described here.

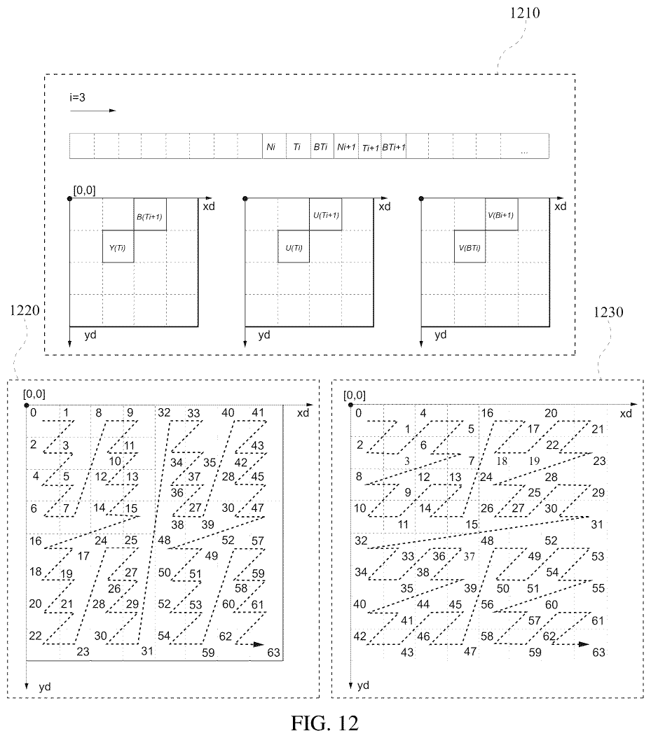

For example, a general continuous-packing process is illustrated as FIG. 12. FIG. 12 shows a schematic diagram illustrating an example of video components for displacement coefficients in an 8×8 packing block. An upper part 1210 in FIG. 12 illustrates a two-dimensional displacement projection from a two-dimensional (2D) scan order (such as a Morton code with an index i, e.g., i=3) for displacement coefficients (such as . . . , Nᵢ, Tᵢ, BTᵢ, Nᵢ₊₁, Tᵢ₊₁, and BTᵢ₊₁, . . . ) into two elements (such as Y(Nᵢ) and Y(Nᵢ₊₁)) in a Y-plane, two elements (such as U(Tᵢ) and U(Tᵢ₊₁)) in a U-plane, and two elements (such as V(BTᵢ) and V(BTᵢ₊₁)) in a V-plane. Illustrations as lower left and lower right parts 1220 and 1230 in FIG. 12 are different examples of a 2D scan order from a first index numbered as 0 at position located at [0,0] to a last index numbered as 63 for video component, e.g., a Z-scan order, such as a Morton code scan order, but it is not intended to limit the description here. For example, Hilbert or other space filling curve can be used in different scenarios.

Understandably, the nature of the lifting transform used in displacement coefficient coding leads to independent subdivision levels with a separate set of coefficients required for reconstruction. In a coding schema, all coefficients are continuously allocated to a 2D image, such as illustrated in FIG. 12.

In the present disclosure, examples are provided for mapping 3D displacement coefficients to a 2D surface and further performing video coding that clearly distinguishes samples in the image belonging to specified levels of details, as follows.

For example, in the present disclosure, a modified processing schema is suggested to that a single LoD(n) including LoD components associated with three displacement components is aligned in an image at a boundary of a first one of coding tree unit (CTU) blocks within a slice, such as padding at least one dummy code, such as at least one empty displacement sample with a default value (e.g., 2\hat{ }(bitDepth−1), or “0”), in the present LoD(n) to fill up the remainder unoccupied space in the present CTU(n) to make that samples of the following LoD are arranged from the first location in the following CTU block within a following slice. In this way, the samples of different LoD are arranged in a slice-aligned packing manner. Therefore, in the present disclosure, partial decoding can be supported by selectively decoding some dedicated slice-aligned LoD of all slice-aligned LoD. For example, each LoD including LoD components associated with three displacement components may correspond to a dedicated slice starting from a low LoD to a high LoD.

For example, any unoccupied sample (such as being located at a location in the present CTU away from a slice boundary between the present and following slices) may be assigned a value using a padding method (such as zero padding) from previously available models.

In an example, the number of displacement coefficients retrieved for LoD reconstruction can be signaled in a displacement component header. Alternatively, in another example, the number of displacement coefficients corresponding to a certain LoD can be derived using information about subdivision schema and a number of vertexes decoded from the base mesh bitstream.

For example, a face subdivision process can be implemented in several ways that depend on the original mesh content to accommodate the topology and corresponding complexity of the mapping.

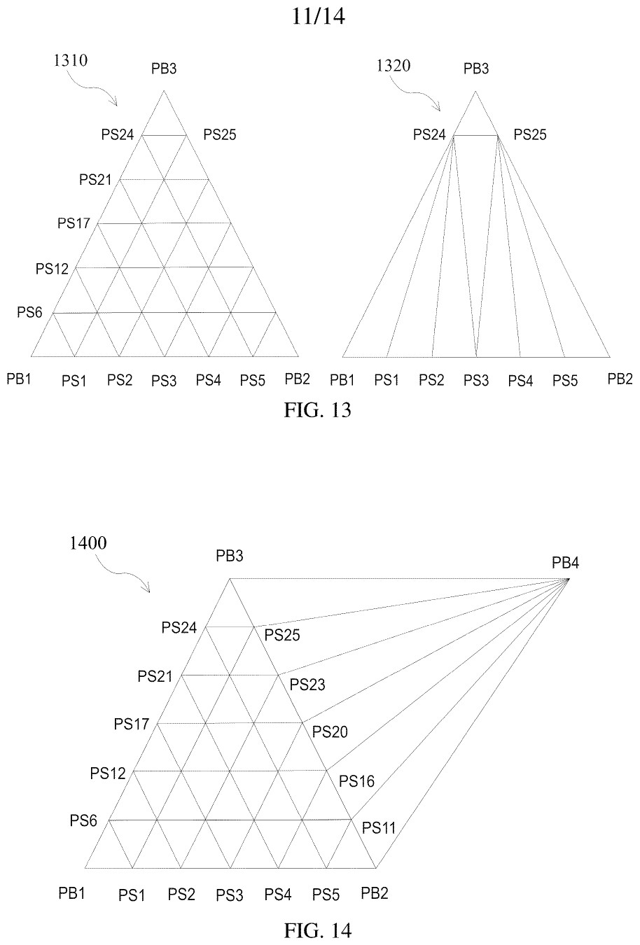

For example, FIG. 13 shows a schematic diagram illustrating examples of geometry subdivision process. As shown in FIG. 13, the left part illustrates a fully recursive subdivision process in a triangular face 1310 defined by vertices PB1, PB2, and PB3, in which subdivision points, such as PS1, PS2, PS3, PS4, PS5, PS6, . . . , PS12, . . . , PS17, . . . , PS21, . . . , PS24, and PS25, are assigned in a bottom-up manner, to generate lines between those subdivision points as edges of thirty-six fully-subdivided triangles with the same area recursively.

As shown in FIG. 13, the right part illustrates a partial subdivision process in a triangular face 1320 defined by vertices PB1, PB2, and PB3, in which subdivision points, such as PS1, PS2, PS3, PS4, PS5, PS24, and PS25, are assigned in a bottom-up manner, to generate fewer lines, such as “PS1-PS24”, “PS2-PS24”, “PS3-PS24”, “PS3-PS25”, “PS4-PS25”, “PS5-PS25”, and “PS24-PS25”, as edges of eight partially-subdivided triangles with different shapes. In this example, each subdivision point can be connected to another subdivision point or other subdivision points.

In another example, a hybrid subdivision combined with a fully recursive subdivision and a partial subdivision is provided. FIG. 14 shows a schematic diagram illustrating an example 1400 of a hybrid geometry subdivision process. As shown in FIG. 14, one triangular face defined by vertices PB1, PB2, and PB3 and another triangular face defined by vertices PB2, PB3, and PB4 belong to different tiles or slices with varying characteristics of subdivision are illustrated, wherein an edge defined by vertices PB2 and PB3 is a boundary edge for two mesh tiles. As shown in FIG. 14, the triangular face defined by vertices PB1, PB2, and PB3 has triangles with edges recursively subdivided between subdivision points, such as PS1, PS2, PS3, PS4, PS5, PS6, . . . , PS11, PS12, . . . , PS16, PS17, . . . , PS20, PS21, . . . , PS23, PS24, and PS25; the triangular face defined by vertices PB2, PB3, and PB4 has six triangles with edges subdivided between a same vertex and different subdivided points, such as “PB4-PS11”, “PB4-PS16”, “PB4-PS20”, “PB4-PS23”, and “PB4-PS25”.

Understandably, because the subdivision process is nonlinear and may have different behavior, it is only possible to explicitly signal the number of vertices per LoD in the displacement mesh parameter or a picture parameter set associated with visual volumetric video-based coding (V3C).

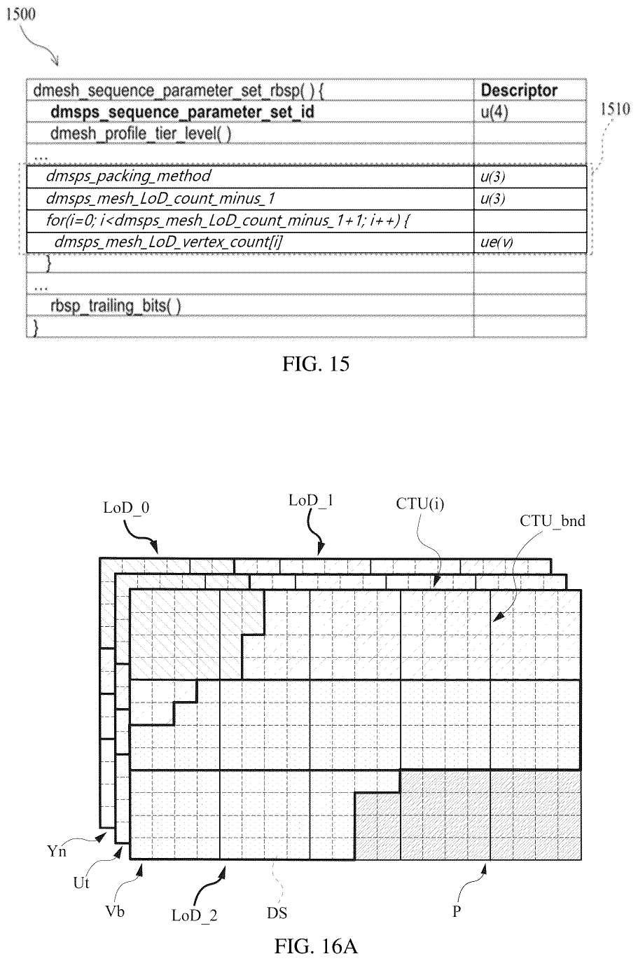

In an example of a displacement mesh parameter, FIG. 15 shows a table 1500 illustrating a syntax structure associated with a function, dmesh_sequence_parameter_set_rbsp( ), in which “u(n)” refers to a descriptor associated with a syntax element for a n-bit(s) unsigned integer with n being equal to a positive integer, such as 3, 4, or . . . , “ue(v)” refers to a descriptor associated with a syntax element for unsigned integer exponential Golomb coding, and there are a syntax element “dmsps_sequence_parameter_set_id” and functions “dmesh_profile_tier_level( )” and “rbsp_trailing_bits( )”.

It should be noted that, in FIG. 15, as shown in a box 1510 between the functions “dmesh_profile_tier_level( )” and “rbsp_trailing_bits( )”, a plurality of syntax elements such as “dmsps_packing_method” and “dmsps_mesh_LoD_count_minus_1” are introduced, and an iterative loop with a variable i from 0 incremental to a maximum integer less than a value of the syntax element “dmsps_mesh_LoD_count_minus_1”+1 is also introduced. In the iterative loop with the variable i, operations are performed on each of different integers (such as 0, 1, 2, . . . ) defined by the variable i, and a syntax element “dmsps_mesh_LoD_vertex_count[i]” indexed with the variable i is introduced.

For example, as shown in FIG. 15, the syntax element “dmsps_packing_method” refers to a packing method used for displacement coefficients allocation. For example, if a value of the syntax element “dmsps_packing_method” is equal to 0, then the displacement coefficients (samples) are packed to different color planes in YUV 4:4:4 format with no padding between LoDs; if the value of the syntax element “dmsps_packing_method” is equal to 1, then the displacement coefficients (samples) are packed to different color planes in YUV 4:4:4 format with padding between LoDs with alignment of start to the CTU boundary (e.g., the boundary of one of the CTUs in different 2D planes); if the value of the syntax element “dmsps_packing_method” is equal to 2, then the displacement coefficients (samples) are packed to single color plane in YUV 4:0:0 format with no padding between LoDs; if the value of the syntax element “dmsps_packing_method” is equal to 3, then the displacement coefficients (samples) are packed to single color plane in YUV 4:0:0 format with padding between LoDs with alignment of start to the CTU boundary (e.g., the boundary of the first one of the CTUs within one of slices in a 2D plane).

In addition, as shown in FIG. 15, the syntax element “dmsps_mesh_LoD_count_minus_1” refers to a value of the syntax element “dmsps_mesh_LoD_count_minus_1” plus one indicating the number of levels of details for the displacement mesh sub-bitstream. Further, a syntax element “dmsps_mesh_transform_id” (not shown) can be applied to indicate the wavelet transform id used in the displacement mesh codec used to encode the displacement mesh coefficients in the displacement mesh substream. It could be associated with a specific displacement mesh transform through the predefined transform in a look-up table, or it could be explicitly indicated with an SEI message as in the V3C specification.

Furthermore, as shown in FIG. 15, the syntax element “dmsps_mesh_LoD_vertex_count[i]” refers to a vertex_count to indicate a difference between the number of vertexes in a level of details such as LoD(i) and the number of vertexes in another level of details such as LoD(i−1). In an example, the difference indicates padded symbols in LoD(i) which can be discarded in a decoding process. In another example, the syntax element “dmsps_mesh_LoD_vertex_count[i] can be used to indicate a number of samples directly in LoD with index “i”.

In the present disclosure, an example of an encoding process is provided for illustration to efficiently encode geometry displacement coefficients in a mesh content including several stages as discussed below.

Stage 1: Mesh segmentation is a step that creates segments or blocks of mesh content representing individual objects/regions of interest/volumetric tiles, semantic blocks, etc. The number of subdivisions is defined by a value of the syntax element “dmsps_mesh_transform_width_minus_1”+1.

Stage 2: Mesh decimation creates a base mesh, and the base mesh is coded with an undefined static mesh encoder. The base mesh is decoded and recursively subdivided to the level of details defined by the syntax element dmsps_mesh_LoD_count_minus_1+1. The result of subdivision is sored in the syntax element “dmsps_mesh_LoD_vertex_count[i]” per each LoD indexed by i.

Stage 3: Mesh displacements are calculated between the subdivided mesh and the original surface for each level of transform. The displacements are processed with a wavelet transform indicated by the syntax element “dmsps_mesh_transform_id” such as shown in the syntax structure associated with the function, dmesh_sequence_parameter_set_rbsp( ).

Stage 4: Wavelet transform coefficients are converted to a fix-point representation with a precision indicated in the coded bitstream at either slice, picture, or sequence level.

Stage 5: The quantized wavelet coefficients are scanned along a 3D space scanning pattern (e.g. Morton, Hilbert, or along other space filling curve) within each LoD, forming three one-dimensional arrays per each component.

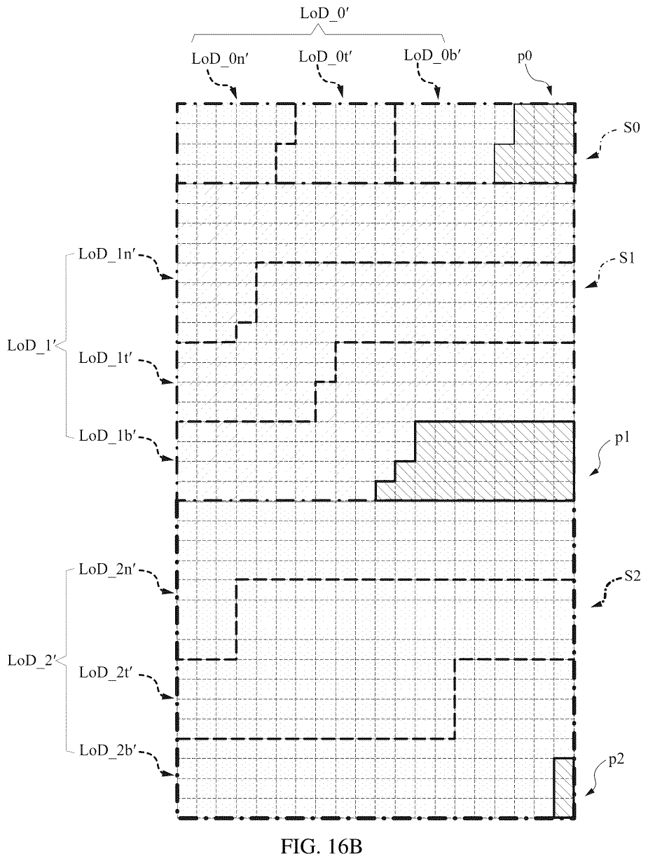

For example, as shown in FIGS. 16A and 16B, which show examples of LoD-based single plane packing for displacement wavelet coefficients in 2D displacement samples. Taking coding tree units in slices as an example, FIG. 16A illustrates a continuous-packing approach for different 2D planes, and FIG. 16B illustrates a slice-aligned packing approach for a single 2D plane.

As shown in FIG. 16A, displacement samples DS of different components (such as associated with normal, tangent, and bi-tangent) belonging to the same LoD (such as LoD_0, LoD_1, or LoD_2, . . . ) are arranged into different planes (such as Y, U, V planes Yn, Ut, Vb for normal, tangent, and bi-tangent) with a padding portion P, wherein each plane is divided into a plurality of block, such as a CTU(i) having 4*4 elements bounded by a CTU boundary CTU_bnd.

As shown in FIG. 16B, different components (such as associated with different displacement components) of the same LoD (such as LoD_0′ LoD_1′, or LoD_2′, . . . ) are arranged into a single plane (such as Y plane). For example, each LoD including components associated with normal, tangent, and bi-tangent displacement components are arranged into one of a plurality of regions including one or more slices (such as five blocks laterally arranged side by side to form a slice), and a padding portion is used for each LoD to fill up the remaining space within a region.

For example, as shown in FIG. 16B, a first LoD (shown as LoD_0′) that includes LoD components (shown as LoD_0n′, LoD_0t′, and LoD_0b′ associated with normal, tangent, and bi-tangent) is arranged into a first region S0 (e.g., occupying one slice) with a padding portion p0 (e.g., having fourteen padding elements). Also, FIG. 16B shows that a second LoD (shown as LoD_1′) including LoD components (shown as LoD_1n′, LoD_1t′, and LoD_1b′ associated with normal, tangent, and bi-tangent) is arranged into a second region S1 (such as occupying four slices) with a padding portion p1 (such as having thirty-five padding elements more than sixteen element in a single block), and a third LoD (shown as LoD_2′) including LoD components (shown as LoD_2n′, LoD_2t′, and LoD_2b′ associated with normal, tangent, and bi-tangent) is arranged into a third region S2 (such as occupying four slices) with a padding portion p2 (such as having three padding elements). Thus, each LoD is aligned with a CTU that is the first one of blocks within one region.

In some embodiment, as shown at the box 1010 in FIG. 10 illustrating a packing process, wherein the packing, in the slice-boundary-aligned arrangement, the plurality of samples belonging to the plurality of levels of detail associated with the plurality of displacement components, into the two-dimensional plane including the plurality of regions, includes: packing a respective portion of the plurality of samples belonging to a respective one of the plurality of levels of detail into a respective one of the plurality of regions by starting with a first index associated with a two-dimensional scan order for the first one of the plurality of blocks within the respective one of the plurality of regions.

Correspondingly, in some embodiment, as shown at the box 1110 in FIG. 11 illustrating an unpacking process corresponding to the packing process, wherein the unpacking, in the slice-boundary-aligned arrangement, the plurality of samples belonging to the plurality of levels of detail associated with the plurality of displacement components, from the two-dimensional plane including the plurality of regions, includes: unpacking a respective portion of the plurality of samples belonging to a respective one of the plurality of levels of detail from a respective one of the plurality of regions by starting with a first index associated with a two-dimensional scan order for the first one of the plurality of blocks within the respective one of the plurality of regions.

For example, as shown in FIG. 16B, several LoDs, such as LoD_0′, LoD_1′, and LoD_2′, are discontinuously packed in the slice-boundary-aligned arrangement in which samples of one LoD are aligned (such as starting) with a first index (such as “0”) associated with a two-dimensional scan order (e.g., shown as parts 1220 and 1230 in FIG. 12). As an example, as shown in FIG. 16B, assuming there are the plurality of samples belonging to the plurality of levels of detail associated with the plurality of displacement components, such as samples allocated in components (e.g., LoD_0n′, LoD_0t′, and LoD_0b′) within a first LoD LoD_0′, components (e.g., LoD_1n′, LoD_1t′, and LoD_1b′) within a second LoD LoD_1′, and components (e.g., LoD_2n′, LoD_2t′, and LoD_2b′) within a third LOD LoD_2′, thereby performing a process for unpacking a respective portion (such as twenty-two samples) of the plurality of samples belonging to a respective one (such as LoD_0n′) of the plurality of levels of detail from a respective one (such as S0) of the plurality of regions by starting with a first index (such as 0) associated with a two-dimensional scan order for the first one (such as the first 4*4 block for LoD_0n′) of the plurality of blocks within the respective one of the plurality of regions.

In some embodiment, as shown at the box 1010 in FIG. 10 illustrating the packing process, wherein the packing the respective portion of the plurality of samples belonging to the respective one of the plurality of levels of detail into the respective one of the plurality of regions by starting with the first index associated with the two-dimensional scan order for the first one of the plurality of blocks within the respective one of the plurality of regions includes: determining, based on a last-sample index associated with the two-dimensional scan order for a last sample belonging to the respective one of the plurality of levels of detail into the respective one of the plurality of regions, whether at least one dummy code (such as zero or a specific value) within the respective one of the plurality of regions after the last-sample index is padded, e.g., including: in response to determining that the last-sample index is not equal a last-code index associated with the two-dimensional scan order for a last element within the last one of the plurality of blocks within the respective one of the plurality of regions, padding at least one dummy code within the respective one of the plurality of regions from the following index next to the last-sample index to the last-code index; and in response to determining that the last-sample index is equal the last-code index, no padding any dummy code within the respective one of the plurality of regions.

Correspondingly, in some embodiment, as shown at the box 1110 in FIG. 11 illustrating the unpacking process, wherein the unpacking the respective portion of the plurality of samples belonging to the respective one of the plurality of levels of detail from the respective one of the plurality of regions by starting with the first index associated with the two-dimensional scan order for the first one of the plurality of blocks within the respective one of the plurality of regions includes: determining, based on a last-sample index associated with the two-dimensional scan order for a last sample belonging to the respective one of the plurality of levels of detail from the respective one of the plurality of regions, whether at least one dummy code (such as zero or a specific value) within the respective one of the plurality of regions after the last-sample index is discarded, e.g., including: in response to determining that the last-sample index is not equal a last-code index associated with the two-dimensional scan order for a last element within the last one of the plurality of blocks within the respective one of the plurality of regions, discarding at least one dummy code within the respective one of the plurality of regions from the following index next to the last-sample index to the last-code index; and in response to determining that the last-sample index is equal the last-code index, no discarding any dummy code within the respective one of the plurality of regions. The example is provided as follows.

For example, as shown in FIG. 16B, the samples, such as a plurality of quantized transform coefficients, a plurality of transformed coefficients, or a plurality of displacement coefficients associated with different displacement components, are converted to a 2D image according to LoD and aligned with boundaries of slices due to inserting padding portions in blocks within each region including at least one slice. For example, there are a first padding portion p0 from the following index (such as idx1+1) next to the last-sample index (such as idx1=(a block number for a block where the last sample for the bi-tangent component of a LoD locates<<m)+a block index of the last sample for the bi-tangent component of the LoD, wherein “<<” is a symbol of the left shifting indicating a calculation of a power of 2, and m is an positive integer equal to or more than a bit number of the block index) to the last-code index (such as idx2=(a maximum block number in the region<<m)+a maximum block index) within a region S0 for a first LoD LoD_0′, a second padding portion p1 from the following index next to the last-sample index to the last-code index within a region S1 for a second LoD LoD_1′, and a third padding portion p2 from the following index next to the last-sample index to the last-code index within a region S2 for a third LoD LoD_2′. Finally, the first padding portion p0 including fourteen padding elements (such as dummy codes), the second padding portion p1 including thirty-five padding elements, and the third padding portion p2 including three padding elements are provided for the overall 2D plane. In an example, the unoccupied symbols in the region can be padded using one of the padding methods (e.g. zero-padding for padding zero as the padding element). Thus, the samples within each LoD are aligned with a boundary of the first one slice within the region in a slice-boundary-aligned arrangement.

For example, using such an approach shown in FIG. 16B, each LoD can be clearly signaled as indicated in a bitstream associated with coded displacement components. Each LoD can be assigned to a unique slice. At the decoder stage, a partial reconstruction up to the desired LoD can be achieved by stopping decoding at a given number of slices. In such a way, padded symbols (e.g., dummy codes) in one region for LoD(i) can be discarded using the dmsps_mesh_LoD_vertex_count[i].

In the present disclosure, an example of a decoding process is an inverse of the encoding process and including several stages as discussed below.

Stage 1: The base mesh is decoded from geometry bitstream and recursively subdivided to the level of details defined by the encoder.

Stage 2: A coded bitstream for geometry displacements is obtained and decoded with a codec corresponding to a decoder associated with the syntax element “dmsps_mesh_codec_id”. It should be noted that the decoding process can be terminated at any given incremental level of details if LoD is assigned to an independent slice. In this case, it is not required to decode all the elements of the displacement coefficients for the mesh reconstruction.

Stage 3: The displacement wavelet coefficients are processed with an inverse wavelet transform indicated by the syntax element “dmsps_mesh_transform_id”.

Stage 4: Mesh displacements are applied to the subdivided base mesh at each transform level recursively to generate the reconstructed mesh consisting of blocks representing individual objects/regions of interest/volumetric tiles, semantic blocks, etc.

The description is introduced for the illustration mentioned above but is not limited to the description here. Other examples are provided as follows.

For example, in the present disclosure, the overall idea of padding is used to align the data in the image to an occupation size of a slice including a plurality of blocks, such as macroblocks (MB), coding tree units (CTU), transform units (TU), prediction units (PU), or coding units (CU), in a corresponding image/video codec used for displacement components coding.

For example, shifting all the samples associated with LoDs to a certain value is used, e.g., the main idea is to keep samples aligned to a boundary of a slice (such as a boundary of a first one of blocks within the first one slice in a region), such as aligning samples with a starting index of indices within the first block within the region.

In some embodiment, as shown at the box 1010 in FIG. 10, in which in response to determining that the last-sample index is not equal the last-code index associated with the two-dimensional scan order for the last element within the last one of the plurality of blocks within the respective one of the plurality of regions, padding at least one dummy code within the respective one of the plurality of regions from the following index next to the last-sample index for the last sample to the last-code index, includes: determining, based on a number of the respective portion of the plurality of samples belonging to the respective one of the plurality of levels of detail and a slice size, a number of at least one dummy code within the respective one of the plurality of regions.

Correspondingly, in some embodiment, as shown at the box 1110 in FIG. 11, in which in response to determining that the last-sample index is not equal the last-code index associated with the two-dimensional scan order for the last element within the last one of the plurality of blocks within the respective one of the plurality of regions, discarding at least one dummy code within the respective one of the plurality of regions from the following index next to the last-sample index for the last sample to the last-code index, includes: determining, based on a number of the respective portion of the plurality of samples belonging to the respective one of the plurality of levels of detail and a slice size, a number of at least one dummy code within the respective one of the plurality of regions. The example is provided as follows.

For example, padding information can be provided according to a number of the respective portion of the plurality of samples belonging to the respective one of the plurality of levels of detail and a slice size, e.g., as shown in FIG. 16B, the first LoD LoD_0′ has sixty-six samples, and a slice has eighty elements, the first padding portion then has fourteen padding elements.

In an example, padding information such as a number of symbols for each LoD (such as being indicative of a syntax element “numSymbolsInLod”) can be discussed as following cases.

In some embodiment, as shown at the box 1010 in FIG. 10 and the table 1500 in FIG. 15, wherein the determining, based on the number of the respective portion of the plurality of samples belonging to the respective one of the plurality of levels of detail and the slice size, the number of dummy code within the respective one of the plurality of regions, includes: encoding a syntax structure into a bitstream associated with the respective one of the plurality of displacement components, including: encoding a plurality of syntax elements associated with a dmsps-packing-method code and a dmsps-mesh-LoD-count-minus-1 code; and performing a respective one of a plurality of operations defined by an iterative loop with a variable from zero incremental to a maximum integer less than a sum of a value of the dmsps-mesh-LoD-count-minus-1 code plus one, including: encoding a syntax element associated with a dmsps-mesh-LoD-vertex-count code indexed by the variable; and determining, based on the syntax element associated with the dmsps-mesh-LoD-vertex-count code indexed by the variable, the number of the respective portion of the plurality of samples belonging to the respective one of the plurality of levels of detail.

Correspondingly, in some embodiment, as shown at the box 1110 in FIG. 11 and the table 1500 in FIG. 15, wherein the determining, based on the number of the respective portion of the plurality of samples belonging to the respective one of the plurality of levels of detail and the slice size, the number of dummy code within the respective one of the plurality of regions, includes: decoding a syntax structure from a bitstream associated with the respective one of the plurality of displacement components, including: decoding a plurality of syntax elements associated with a dmsps-packing-method code and a dmsps-mesh-LoD-count-minus-1 code; and performing a respective one of a plurality of operations defined by an iterative loop with a variable from zero incremental to a maximum integer less than a sum of a value of the dmsps-mesh-LoD-count-minus-1 code plus one, including: decoding a syntax element associated with a dmsps-mesh-LoD-vertex-count code indexed by the variable; and determining, based on the syntax element associated with the dmsps-mesh-LoD-vertex-count code indexed by the variable, the number of the respective portion of the plurality of samples belonging to the respective one of the plurality of levels of detail. The example is provided as below.

### Case 1:

In some embodiment, as shown at the box 1010 in FIG. 10, the box 1110 in FIG. 11, and the table 1500 in FIG. 15, wherein the determining, based on the syntax element associated with the dmsps-mesh-LoD-vertex-count code indexed by the variable, the number of the respective portion of the plurality of samples belonging to the respective one of the plurality of levels of detail, includes: assigning the number of the respective portion of the plurality of samples belonging to the respective one of the plurality of levels of detail being equal to a value of the syntax element associated with the dmsps-mesh-LoD-vertex-count code indexed by the variable. The example is provided as below.

For example, the syntax element “dmsps_mesh_LoD_vertex_count[i] discussed above can be used to indicate a number of samples directly in LoD with index “i”.

### Case 2:

In some embodiment, as shown at the box 1010 in FIG. 10, the box 1110 in FIG. 11, and the table 1500 in FIG. 15, wherein the determining, based on the syntax element associated with the dmsps-mesh-LoD-vertex-count code indexed by the variable, the number of the respective portion of the plurality of samples belonging to the respective one of the plurality of levels of detail, includes: determining, based on the syntax element associated with the dmsps-mesh-LoD-vertex-count code indexed by the variable, a difference between the number of the respective portion of the plurality of samples belonging to the respective one of the plurality of levels of detail and a number of a following portion of the plurality of samples belonging to a following one of the plurality of levels of detail next to the respective one of the plurality of levels of detail; and determining, based on the difference and the number of the following portion of the plurality of samples belonging to the following one of the plurality of levels of detail next to the respective one of the plurality of levels of detail, the number of the respective portion of the plurality of samples belonging to the respective one of the plurality of levels of detail. The example is provided as below.

For example, the syntax element “dmsps_mesh_LoD_vertex_count[i] can be used to indicate a difference of numbers of samples between LoD[i] and LoD[i−1] discussed above.

### Case 3:

In some embodiment, as shown at the box 1010 in FIG. 10, the box 1110 in FIG. 11, wherein the determining, based on the number of the respective portion of the plurality of samples belonging to the respective one of the plurality of levels of detail and the slice size, the number of dummy code within the respective one of the plurality of regions, includes: determining, base on the number of the respective portion of the plurality of samples belonging to the respective one of the plurality of levels of detail associated with a base mesh vertex count from a base bitstream and subdivision information (e.g., the number, connectivity, and/or distribution of subdivided points, etc.) as a subdivision process being recursively performed, the number of samples belonging to the respective one of the plurality of levels of detail.

For example, a base mesh vertex count from a decoded base bitstream and a subdivision method to derive a number of samples in each LoD can be used when the subdivision process is recursively operated.

In addition, as an example, it can be derived as a number of padded symbols using a number of samples in each LoD and such as a syntax element “packingSliceSize” to derive the number of elements.

Alternatively, as another example, it can be derived as a packing block size from “profile, tire, or level” information associated with a V3C bitstream.

Further, padding information can be provided and expressed as equations shown below.

$$numPaddedSymbols = numSymbolsInLod / packingSliceSize * ( packingSliceSize + 1 ) .$$

It should be noted that “/” symbol denotes an integer division e.g. “3/2=1”, the numPaddedSymbols indicates a number of padded symbols such as dummy codes, the numSymbolsInLod indicates a number of symbols in LoD, the packingSliceSize indicates a packing slice size such as 4×4×5 samples.

For example, a standard draft is only implemented using Case 1 and directly indicates packingSliceSize in the bitstream. In this example, an image packing slice size is 80.

In general, a good way to modify the above equation is to assume packing is square, then it is needed to change the equation as below.

$$numPaddedSymbols = numSymbolsInLod / ( packingSliceSize \hat{} 2 ) * ( ( packingSliceSize + 1 ) \hat{} 2 ) ,$$

Alternatively, even using a power of 2 (i.e., shown as “A”) as a restriction on allowed slice sizes can be applied because this is consistent with video codecs.

In addition, signal as dmsps_packing_slice_size_log 2_minus3 can be provided, then packingSliceSize=2 (dmsps_packing_slice_size_log 2_minus3+3).

For example, the number of symbols in any LoD may be equal or smaller than the number of padded symbols in general.

Example: if have a base mesh (LoD0) of 3 vertices (one triangular face) and our packing slice is 80 elements (4×4×5), then LoD1 is 9 and padding is 71; LoD2 is 27 and padding is 53; LoD3 is 30 and padding is 50.

In a case that vertices and degenerated triangles do not have duplicated, a total number of vertices is 42, and the displacements image with padding has 192 samples. In reality however the number of samples in LoD0 is close to 1000, and the displacements are usually 2000 for LoD1, 7000 for LoD2 and 50000 for LoD3.

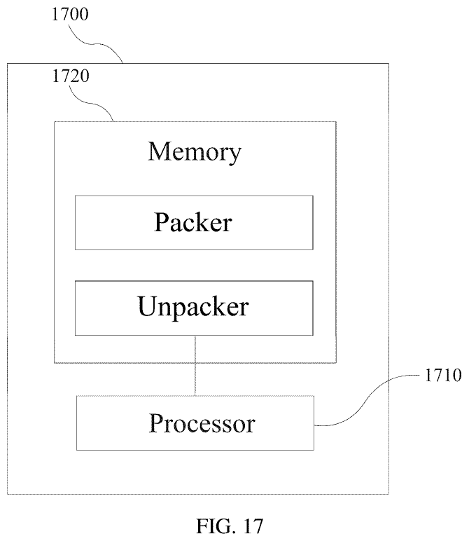

Further, any suitable computing system can be used for performing the operations for replacement information packing like a packer or replacement information unpacking like an unpacker described herein. For example, FIG. 17 depicts an example of a computing device 1700 that can implement methods such as computer-implemented methods for a packing process or an unpacking process that can be included in an bitstream encoding/decoding process, herein.

In some embodiments, the computing device 1700 can include a processor 1710 that is coupled to a memory 1720 and is configured to execute program instructions stored in the memory 1720 to perform the operations for implementing a computer-implemented method associated with a packer and/or an unpacker.

For example, the processor 1710 may include a microprocessor, an application-specific integrated circuit (“ASIC”), a state machine, or other processing device. The processor 1710 can include one or more processing units. Such a processor can include or may be in communication with a computer-readable medium storing instructions that, when executed by the processor 1710, cause the processor to perform the operations described herein. The memory 1720 can include any suitable non-transitory computer-readable medium.

For example, the computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer programming language, including, for example, C, C++, C#, Visual Basic, Java, Python, Perl, JavaScript, and ActionScript.

In some embodiments, the present disclosure provides that a system includes: a processor; and a memory coupled to the processor, wherein the processor is configured to execute program instructions stored in the memory to perform any one of the above computer-implemented methods associated with a packing process.

In some embodiments, the present disclosure provides that a non-transitory computer-readable medium having program code stored thereon, the program code executable by a processor to execute any one of the above computer-implemented methods associated with a packing process.

In some embodiments, the present disclosure provides that a system includes: a processor; and a memory coupled to the processor, wherein the processor is configured to execute program instructions stored in the memory to perform any one of the above computer-implemented methods associated with an unpacking process.

In some embodiments, the present disclosure provides that a non-transitory computer-readable medium having program code stored thereon, the program code executable by a processor to execute any one of the above computer-implemented methods associated with an unpacking process.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan provided by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A computer-implemented method, comprising:
unpacking, in a slice-boundary-aligned arrangement, a plurality of samples belonging to a plurality of levels of detail (LoD) associated with a plurality of displacement components, from a two-dimensional plane comprising a plurality of regions, wherein each of the plurality of regions comprises at least one slice comprising a plurality of blocks.

2. The method of claim 1, wherein each of the plurality of levels of detail includes a plurality of LoD components associated with the plurality of displacement components comprising a normal displacement component, a tangent displacement component, and a bi-tangent displacement component.

3. The method of claim 1, wherein the unpacking, in the slice-boundary-aligned arrangement, the plurality of samples belonging to the plurality of levels of detail associated with the plurality of displacement components, from the two-dimensional plane comprising the plurality of regions, comprises:
unpacking a respective portion of the plurality of samples belonging to a respective one of the plurality of levels of detail from a respective one of the plurality of regions by starting with a first index associated with a two-dimensional scan order for the first one of the plurality of blocks within the respective one of the plurality of regions.

4. The method of claim 3, wherein the unpacking the respective portion of the plurality of samples belonging to the respective one of the plurality of levels of detail from the respective one of the plurality of regions by starting with the first index associated with the two-dimensional scan order for the first one of the plurality of blocks within the respective one of the plurality of regions comprises:
determining, based on a last-sample index associated with the two-dimensional scan order for a last sample belonging to the respective one of the plurality of levels of detail from the respective one of the plurality of regions, whether at least one dummy code within the respective one of the plurality of regions after the last-sample index is discarded.

5. The method of claim 4, wherein the determining, based on the last-sample index associated with the two-dimensional scan order for the last sample belonging to the respective one of the plurality of levels of detail from the respective one of the plurality of regions, whether at least one dummy code within the respective one of the plurality of regions after the last-sample index is discarded, comprises:
in response to determining that the last-sample index is not equal a last-code index associated with the two-dimensional scan order for a last element within the last one of the plurality of blocks within the respective one of the plurality of regions, discarding at least one dummy code within the respective one of the plurality of regions from the following index next to the last-sample index to the last-code index; and
in response to determining that the last-sample index is equal the last-code index, no discarding any dummy code within the respective one of the plurality of regions.

6. The method of claim 5, wherein in response to determining that the last-sample index is not equal the last-code index associated with the two-dimensional scan order for the last element within the last one of the plurality of blocks within the respective one of the plurality of regions, discarding at least one dummy code within the respective one of the plurality of regions from the following index next to the last-sample index for the last sample to the last-code index, comprises:
determining, based on a number of the respective portion of the plurality of samples belonging to the respective one of the plurality of levels of detail and a slice size, a number of at least one dummy code within the respective one of the plurality of regions.

7. The method of claim 6, wherein the determining, based on the number of the respective portion of the plurality of samples belonging to the respective one of the plurality of levels of detail and the slice size, the number of dummy code within the respective one of the plurality of regions, comprises:
decoding a syntax structure from a bitstream associated with the respective one of the plurality of displacement components, comprising:
decoding a plurality of syntax elements associated with a dmsps-packing-method code and a dmsps-mesh-LoD-count-minus-1 code; and
performing a respective one of a plurality of operations defined by an iterative loop with a variable from zero incremental to a maximum integer less than a sum of a value of the dmsps-mesh-LoD-count-minus-1 code plus one, comprising:
decoding a syntax element associated with a dmsps-mesh-LoD-vertex-count code indexed by the variable; and
determining, based on the syntax element associated with the dmsps-mesh-LoD-vertex-count code indexed by the variable, the number of the respective portion of the plurality of samples belonging to the respective one of the plurality of levels of detail.

8. The method of claim 7, wherein the determining, based on the syntax element associated with the dmsps-mesh-LoD-vertex-count code indexed by the variable, the number of the respective portion of the plurality of samples belonging to the respective one of the plurality of levels of detail, comprises:
assigning the number of the respective portion of the plurality of samples belonging to the respective one of the plurality of levels of detail being equal to a value of the syntax element associated with the dmsps-mesh-LoD-vertex-count code indexed by the variable.

9. The method of claim 7, wherein the determining, based on the syntax element associated with the dmsps-mesh-LoD-vertex-count code indexed by the variable, the number of respective portion of the plurality of samples belonging to the respective one of the plurality of levels of detail, comprises:
determining, based on the syntax element associated with the dmsps-mesh-LoD-vertex-count code indexed by the variable, a difference between the number of the respective portion of the plurality of samples belonging to the respective one of the plurality of levels of detail and a number of a following portion of the plurality of samples belonging to a following one of the plurality of levels of detail next to the respective one of the plurality of levels of detail; and
determining, based on the difference and the number of the following portion of the plurality of samples belonging to the following one of the plurality of levels of detail next to the respective one of the plurality of levels of detail, the number of the respective portion of the plurality of samples belonging to the respective one of the plurality of levels of detail.

10. The method of claim 6, wherein the determining, based on the number of the respective portion of the plurality of samples belonging to the respective one of the plurality of levels of detail and the slice size, the number of dummy code within the respective one of the plurality of regions, comprises:
determining, base on the number of the respective portion of the plurality of samples belonging to the respective one of the plurality of levels of detail associated with a base mesh vertex count from a base bitstream and subdivision information as a subdivision process being recursively performed, the number of samples belonging to the respective one of the plurality of levels of detail.

11.-12. (canceled)

13. A system comprising:
a processor; and
a memory coupled to the processor, wherein the processor is configured to execute program instructions stored in the memory to perform:
unpacking, in a slice-boundary-aligned arrangement, a plurality of samples belonging to a plurality of levels of detail (LoD) associated with a plurality of displacement components, from a two-dimensional plane comprising a plurality of regions, wherein each of the plurality of regions comprises at least one slice comprising a plurality of blocks.

14. (canceled)

15. A computer-implemented method, comprising:
packing, in a slice-boundary-aligned arrangement, a plurality of samples belonging to a plurality of levels of detail (LoD) associated with a plurality of displacement components, into a two-dimensional plane comprising a plurality of regions, wherein each of the plurality of regions comprises at least one slice comprising a plurality of blocks.

16. (canceled)

17. The method of claim 15, wherein the packing, in the slice-boundary-aligned arrangement, the plurality of samples belonging to the plurality of levels of detail associated with the plurality of displacement components, into the two-dimensional plane comprising the plurality of regions, comprises:
packing a respective portion of the plurality of samples belonging to a respective one of the plurality of levels of detail into a respective one of the plurality of regions by starting with a first index associated with a two-dimensional scan order for the first one of the plurality of blocks within the respective one of the plurality of regions.

18. The method of claim 17, wherein the packing the respective portion of the plurality of samples belonging to the respective one of the plurality of levels of detail into the respective one of the plurality of regions by starting with the first index associated with the two-dimensional scan order for the first one of the plurality of blocks within the respective one of the plurality of regions comprises:
determining, based on a last-sample index associated with the two-dimensional scan order for a last sample belonging to the respective one of the plurality of levels of detail into the respective one of the plurality of regions, whether at least one dummy code within the respective one of the plurality of regions after the last-sample index is padded.

19. The method of claim 18, wherein the determining, based on the last-sample index associated with the two-dimensional scan order for the last sample belonging to the respective one of the plurality of levels of detail into the respective one of the plurality of regions, whether at least one dummy code within the respective one of the plurality of regions after the last-sample index is padded, comprises:
in response to determining that the last-sample index is not equal a last-code index associated with the two-dimensional scan order for a last element within the last one of the plurality of blocks within the respective one of the plurality of regions, padding at least one dummy code within the respective one of the plurality of regions from the following index next to the last-sample index to the last-code index; and
in response to determining that the last-sample index is equal the last-code index, no padding any dummy code within the respective one of the plurality of regions.

20. The method of claim 19, wherein in response to determining that the last-sample index is not equal the last-code index associated with the two-dimensional scan order for the last element within the last one of the plurality of blocks within the respective one of the plurality of regions, padding at least one dummy code within the respective one of the plurality of regions from the following index next to the last-sample index for the last sample to the last-code index, comprises:
determining, based on a number of the respective portion of the plurality of samples belonging to the respective one of the plurality of levels of detail and a slice size, a number of at least one dummy code within the respective one of the plurality of regions.

21. The method of claim 20, wherein the determining, based on the number of the respective portion of the plurality of samples belonging to the respective one of the plurality of levels of detail and the slice size, the number of dummy code within the respective one of the plurality of regions, comprises:
encoding a syntax structure into a bitstream associated with the respective one of the plurality of displacement components, comprising:
encoding a plurality of syntax elements associated with a dmsps-packing-method code and a dmsps-mesh-LoD-count-minus-1 code; and
performing a respective one of a plurality of operations defined by an iterative loop with a variable from zero incremental to a maximum integer less than a sum of a value of the dmsps-mesh-LoD-count-minus-1 code plus one, comprising:
encoding a syntax element associated with a dmsps-mesh-LoD-vertex-count code indexed by the variable; and
determining, based on the syntax element associated with the dmsps-mesh-LoD-vertex-count code indexed by the variable, the number of the respective portion of the plurality of samples belonging to the respective one of the plurality of levels of detail.

22. The method of claim 21, wherein the determining, based on the syntax element associated with the dmsps-mesh-LoD-vertex-count code indexed by the variable, the number of the respective portion of the plurality of samples belonging to the respective one of the plurality of levels of detail, comprises:
assigning the number of the respective portion of the plurality of samples belonging to the respective one of the plurality of levels of detail being equal to a value of the syntax element associated with the dmsps-mesh-LoD-vertex-count code indexed by the variable.

23. The method of claim 21, wherein the determining, based on the syntax element associated with the dmsps-mesh-LoD-vertex-count code indexed by the variable, the number of the respective portion of the plurality of samples belonging to the respective one of the plurality of levels of detail, comprises:
determining, based on the syntax element associated with the dmsps-mesh-LoD-vertex-count code indexed by the variable, a difference between the number of the respective portion of the plurality of samples belonging to the respective one of the plurality of levels of detail and a number of a following portion of the plurality of samples belonging to a following one of the plurality of levels of detail next to the respective one of the plurality of levels of detail; and
determining, based on the difference and the number of the following portion of the plurality of samples belonging to the following one of the plurality of levels of detail next to the respective one of the plurality of levels of detail, the number of the respective portion of the plurality of samples belonging to the respective one of the plurality of levels of detail.

24. The method of claim 20, wherein the determining, based on the number of the respective portion of the plurality of samples belonging to the respective one of the plurality of levels of detail and the slice size, the number of dummy code within the respective one of the plurality of regions, comprises:
determining, base on the number of the respective portion of the plurality of samples belonging to the respective one of the plurality of levels of detail associated with a base mesh vertex count from a base bitstream and subdivision information as a subdivision process being recursively performed, the number of samples belonging to the respective one of the plurality of levels of detail.

25.-28. (canceled)
